(19) United States
(12) Patent Application Publication
(10) Pub. No.: US 2017/0338763 A1
(43) Pub. Date: Nov. 23, 2017

(54) DRIVING SYSTEM AND DRIVING METHOD OF LINEAR MOTOR

(71) Applicants: Hongxing Wang, Shenzhen (CN); Yao Wang, Shenzhen (CN)

(72) Inventors: Hongxing Wang, Shenzhen (CN); Yao Wang, Shenzhen (CN)

(73) Assignee: AAC Technologies Pte. Ltd., Singapore city (SG)

(21) Appl. No.: 15/417,024

(22) Filed: Jan. 26, 2017

(30) Foreign Application Priority Data
May 20, 2016 (CN) 201610340984.7

(51) Int. Cl. H02P 25/06; H02K 11/215; H02K 11/30; B06B 1/04

(52) U.S. Cl. CPC H02P 25/06; B06B 1/04; H02K 11/215; H02K 11/30

(57) ABSTRACT

The present invention provides a driving method of a linear motor, comprising: S1: providing a motor having a vibrator; S2: inputting a first driving signal to the vibrator to drive the vibrator to vibrate so as to generate a displacement; S3: monitoring the current displacement of the vibrator; S4: determining whether the current displacement of the vibrator is greater than or equal to a preset maximum displacement of the vibrator; S5: if the current displacement of the vibrator is greater than or equal to the preset maximum displacement of the vibrator, providing a second driving signal having a preset duration to the vibrator, so as to provide a electromagnetic force having a direction opposite to the direction of the current displacement; S6: providing the first driving signal to the vibrator again so as to drive the vibrator to continuingly vibrate.

### TECHNICAL FIELD

The present invention relates to a field of linear motor, and more particularly, to a driving system and a driving method of a linear motor.

### BACKGROUND

When a linear motor is driven by an electric signal, the motor will start from rest until the maximum vibration amplitude is reached. Since the velocity is zero when the vibration amplitude is maximum, there is no damping force in the movement of the vibrator. The maximum force Foutput output by the motor is equal to the inertia force of the vibrator of the motor, Finertial, |Foutput|=|Finertial|=|Fspring+Fem|, |Fspring|=|kD|, where k is the stiffness coefficient of a spring, and D is a displacement. When D reaches the maximum value, Fspring also reaches the maximum value. The limit to the maximum displacement amplitude of the motor comes from the spring. The maximum amplitude of the motor is usually limited for a certain motor, so the maximum restoring force of the spring is also limited. Obviously, with a certain displacement, the electromagnetic force Fem must be increased and the direction of the electromagnetic force Fem must be consistent with the direction of the spring force Fspring to increase the output force Foutput.

In general, when the maximum vibration amplitude of the motor is reached, the amplitude of the electric signal is zero, that is, the magnitude of the electromagnetic force is zero. At this time, the output force of the vibrator of the motor is equal to the inertia force of the vibrator of the motor (is also equal to the spring force). Even with some special signals, the amplitude of the electrical signal is not zero when the maximum vibration amplitude of the motor is reached, but typically, the electromagnetic force at this moment can not serve to increase the output force, because the positive direction and negative direction of the electrical signal at this moment is not appropriate or the electrical signal has very low amplitude.

Therefore, it is necessary to provide a new driving system of a linear motor and a driving method thereof.

### SUMMARY

It is an object of the present invention to provide a new driving system and a driving method of a linear motor so that the motor can generate a larger output force with a limited displacement.

A technical aspect of the present invention is as follows: a driving system of a linear motor, comprising: a motor having a vibrator; a detection module for monitoring the current displacement of the vibrator; a signal input module for inputting a first driving signal by which the vibrator is driven to vibrate to generate a displacement and a second driving signal for supplying the vibrator with an electromagnetic force having a direction opposite to the direction of the current displacement; a control module configured to control the signal input module to input the first driving signal to the motor, receive the current displacement of the vibrator transmitted by the detection module and determine whether the current displacement is greater than or equal to the preset maximum displacement of the vibrator; control the signal input module to supply the vibrator with a second driving signal having a preset duration when the monitored current displacement is greater than or equal to the preset maximum displacement; and then control the signal input module to continuingly provide the first driving signal to the vibrator.

In the driving system of a linear motor described above, the detection module is a Hall sensor.

In the driving system of a linear motor described above, the preset period does not exceed 1/20 of the resonance period of the vibrator.

The present invention further provides the following technical aspect: A driving method of a linear motor, comprising: S1: providing a motor having a vibrator; S2: inputting a first driving signal to the vibrator to drive the vibrator to vibrate so as to generate a displacement; S3: monitoring the current displacement of the vibrator; S4: determining whether the current displacement of the vibrator is greater than or equal to a preset maximum displacement of the vibrator; S5: if the current displacement of the vibrator is greater than or equal to the preset maximum displacement of the vibrator, providing a second driving signal having a preset duration to the vibrator, so as to provide a electromagnetic force having a direction opposite to the direction of the current displacement; and S6; providing the first driving signal to the vibrator again so as to drive the vibrator to continuingly vibrate.

In the driving method of a linear motor described above, the driving method further comprises: if the current displacement of the vibrator is less than the preset maximum displacement of the vibrator, the process returns to the step S3 and continues to monitor the current displacement of the vibrator.

In the driving method of a linear motor described above, the driving method further comprises:

S7: determining whether the first driving signal has been stopped, and if the first driving signal is not stopped, the process returns to the step S3.

In the driving method of a linear motor described above, the preset period does not exceed 1/20 of the resonance period of the vibrator.

In the driving method of the linear motor described above, the current displacement of the vibrator is monitored using a Hall sensor.

The invention has the following advantage: the driving method and driving system of a linear motor provided by the present invention enable a motor to generate a larger output force with a limited displacement.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention. Embodiments of the invention are described, by way of example only, with reference to the accompanying drawings, in which:

FIG. 1 is a structural block diagram showing the structure of a linear motor driving system according to the present invention; and

FIG. 2 is a flow chart of a linear motor driving method according to the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Some of the embodiments of the present invention will now be described in further detail with reference to the accompanying drawings.

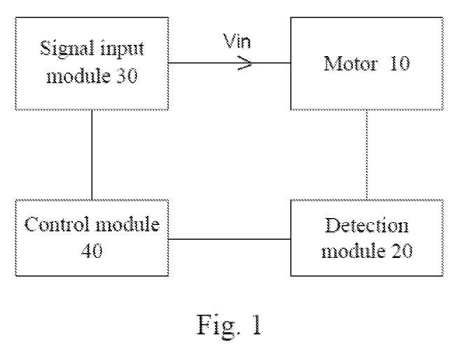

In one embodiment of the present invention, as shown in FIG. 1, provides a driving system of a linear motor that comprises a motor 10 having a vibrator, a detection module 20 for monitoring the current displacement of the vibrator, a signal input module 30, and a control module 40.

The signal input module 30 is configured to input a first driving signal by which the vibrator is driven to vibrate to generate a displacement and a second driving signal for supplying the vibrator with an electromagnetic force having a direction opposite to the direction of its current displacement.

The control module 40 is configured to control the signal input module 30 to input the first driving signal to the motor 10, receive the current displacement of the vibrator transmitted by the detection module 20 and determine whether the current displacement is greater than or equal to the preset maximum displacement of the vibrator. The control module 40 controls the signal input module 30 to supply the vibrator with a second driving signal having a preset duration when the monitored current displacement of the vibrator is greater than or equal to a preset maximum displacement; and then the signal input module 30 is controlled to continuingly provide the first driving signal to the vibrator.

In some of embodiments of the present invention, the motor 10 includes a vibrator positioned inside, and the vibrator is made of magnet. The detection module 20 employs a Hall sensor. The Hall sensor is positioned inside the motor 10 and determines the current displacement of the vibrator by monitoring the magnetic field strength, and converts the current displacement into an electrical signal to be sent to the control module 40. The signal input module 30 inputs the first driving signal to the motor 10 to drive the vibrator to move so as to generate a displacement.

In the control module 40, the maximum displacement of the vibrator is preset, and the current displacement received from the Hall sensor is compared with the preset maximum displacement to determine. The control module 40 controls the signal input module 30 to input the second driving signal to the motor 10 when the current displacement is equal to or slightly greater than the preset maximum displacement, and the second driving signal lasts for a preset duration, typically not exceeding 1/20 of the resonance period of the motor. The direction of the electromagnetic force generated by the vibrator driven by the second driving signal is opposite to the direction of the current displacement. Then, the signal input module 30 is controlled again to supply the first driving signal to the motor 10. The control module 40 determines whether the first driving signal is stopped, if so, the vibration of the vibrator is stopped; if not, the control module 40 continues to monitor the current displacement of the vibrator and sends it to the control module 40 to determine whether the current displacement has reached the preset maximum displacement, If so, the above steps are repeated.

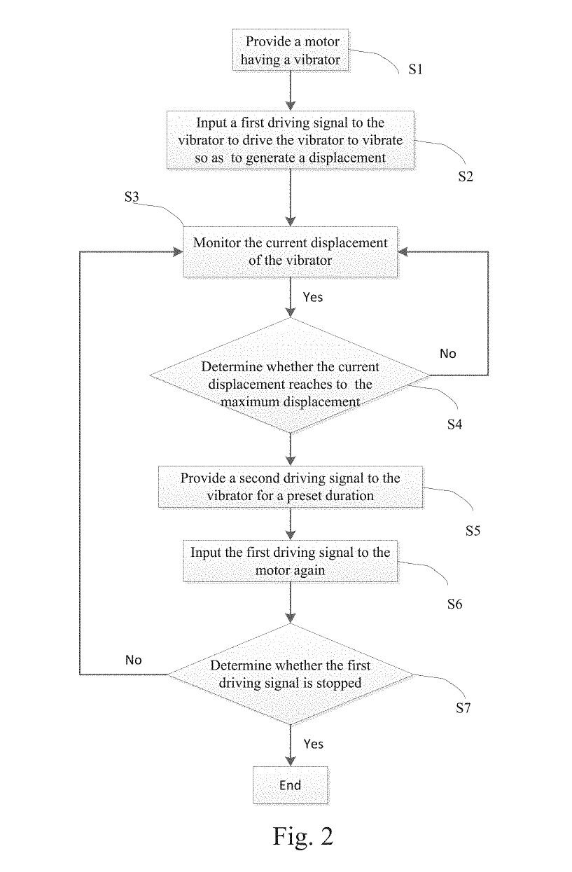

In one embodiment of the present invention, as shown in FIG. 2, provides a method of driving a linear motor, comprising the steps of:

S 1: providing a motor having a vibrator;

S2: the signal input module supplying the first driving signal to the vibrator to drive the vibrator to vibrate so as to generate a displacement;

S3: the detection module monitoring the current displacement of the vibrator, and sending the monitored signal to the control module;

S4: the control module comparing the monitored current displacement with the maximum displacement that is preset in the control module to determine whether the current displacement is equal to or slightly greater than the maximum displacement;

S5: if the current displacement is equal to or slightly greater than the maximum displacement, the control module controlling the signal input module to provide a second driving signal to the vibrator, the second driving signal causing the direction of the electromagnetic force acting on the vibrator to be opposite to the direction of the current displacement for a preset duration, typically not exceeding 1/20 of the resonance period of the vibrator; if the current displacement is less than the maximum displacement, the process returns to the step S3, and the vibrator continues to vibrate and the current displacement of the vibrator is continuously monitored;

S6: the control module controlling the signal input module to switch the second driving signal back to the first driving signal to drive the vibrator to continue to vibrate after the second driving electric signal has lasted for the preset duration;

S7: determining whether the first driving signal has been stopped, and if the first driving signal has been stopped, the vibration of the motor is stopped; and if the first driving signal has not been stopped, the process returns to the step S3 and the steps S3 to S6 are repeated.

With this method, it is possible to increase the maximum acceleration of the vibrator without increasing the displacement of the vibration, that is, the output force of the vibrator is increased and the vibration sense is enhanced.

While the foregoing are merely some embodiments of the invention, it should be noted that modifications may be made thereto by those skilled in the art without departing from the scope of the inventive concept.

1. A driving system of a linear motor, comprising:
a motor having a vibrator;
a detection module configured to monitor current displacement of the vibrator;
a signal input module configured to input a first driving signal for driving the vibrator to vibrate so as to generate a displacement and a second driving signal for supplying the vibrator with an electromagnetic force having a direction opposite to the direction of the current displacement;
a control module configured to control the signal input module to input the first driving signal to the motor, receive the current displacement of the vibrator transmitted by the detection module and determine whether the current displacement is greater than or equal to the preset maximum displacement of the vibrator; control the signal input module to supply the vibrator with a second driving signal having a preset duration when the monitored current displacement is greater than or equal to the preset maximum displacement, so as to provide an electromagnetic force having a direction opposite to the direction of the current displacement; and then control the signal input module to continuingly provide the first driving signal to the vibrator, so as to drive the vibrator to continuingly vibrate.

2. The driving system of a linear motor according to claim 1, wherein the detection module is Hall sensor.

3. The driving system of a linear motor according to claim 2, wherein the preset period does not exceed 1/20 of the resonance period of the vibrator.

4. A driving method of a linear motor, comprising steps of:
S1: providing a motor having a vibrator;
S2: inputting a first driving signal to the vibrator to drive the vibrator to vibrate so as to generate a displacement;
S3: monitoring the current displacement of the vibrator;
S4: determining whether the current displacement of the vibrator is greater than or equal to a preset maximum displacement of the vibrator;
S5: if the current displacement of the vibrator is greater than or equal to the preset maximum displacement of the vibrator, providing a second driving signal having a preset duration to the vibrator, so as to provide an electromagnetic force having a direction opposite to the direction of the current displacement; and
S6: providing the first driving signal to the vibrator again so as to drive the vibrator to continuingly vibrate.

5. The driving method of a linear motor according to claim 4, further comprising:
if the current displacement of the vibrator is less than the preset maximum v of the vibrator, the process returns to the step S3 and continues to monitor the current displacement of the vibrator.

6. The driving method of a linear motor according to claim 4, further comprising:
S7: determining whether the first driving signal has been stopped, and if the first driving signal is not stopped, the process returns to the step S3.

7. The driving method of a linear motor according to claim 4, wherein the preset period does not exceed 1/20 of the resonance period of the vibrator.

8. The driving method of a linear motor according to claim 4, wherein the current displacement of the vibrator is monitored by Hall sensor.
